(19) United States
(12) Patent Application Publication
(10) Pub. No.: US 2019/0289188 A1
(43) Pub. Date: Sep. 19, 2019

(54) SYSTEM AND METHOD OF ADJUSTING POWER OF A LIGHT SOURCE

(71) Applicants: Himax Imaging Limited, Tainan City (TW); Himax Technologies Limited, Tainan City (TW)

(72) Inventors: Biing-Seng Wu, Tainan City (TW); Yu-Yu Sung, Tainan City (TW); Huan-Pin Tseng, Tainan City (TW)

(21) Appl. No.: 15/922,737

(22) Filed: Mar. 15, 2018

(51) Int. Cl. H04N 5/235; G06T 7/521; H04N 5/33

(52) U.S. Cl. CPC H04N 5/2354; H04N 5/33; G06T 7/521; H04N 5/2351

(57) ABSTRACT

A system of adjusting power of a light source includes an image sensor for capturing an image and obtaining gain and exposure; a target object detection unit that detects a target object in the image and finds a size of the target object; a distance determination unit that determines distance of the target object according to the size of the target object; a light energy measuring unit that measures light energy according to the gain and the exposure; and a controller that controllably adjusts power of the light source according to the distance and the light energy.

### BACKGROUND OF THE INVENTION

### 1. Field of the Invention

The present invention generally relates to an image sensor, and more particularly to a system and method of adjusting power of a light-emitting device by an image sensor.

### 2. Description of Related Art

Structured-light (SL) projector is commonly used to project a known pattern on to a scene. The structure-light projector may be adopted in a three-dimensional (3D) scanning system for measuring 3D shape of an object. The SL projector may emit invisible (e.g., infrared or IR) structured light without interfering with other computer vision tasks (or human vision look and feel).

The power of a light-emitting device (e.g., IR light-emitting device) of the SL projector is commonly controlled with both a proximity sensor and an ambient light sensor. The proximity sensor is a sensor capable of detecting presence of nearby objects without any physical contact. FIG. 1A shows one type of proximity sensors. Specifically, an infrared light-emitting diode (LED) emits IR light to an object (or target), and reflected IR light is then sensed by a proximity sensor to detect presence of the object. FIG. 1B shows another type of proximity sensors. Specifically, a light source emits light to an object, and reflected light is sensed by a photodetector to detect distance D of the object by using time of flight (TOF) property of the emitted light (i.e., the time that the emitted light needs to travel to the object and then goes back).

The ambient light sensor is a sensor capable of detecting ambient light power (or energy). FIG. 2A shows a block diagram illustrating an ambient light sensor that mainly includes analog-to-digital converters (ADCs) for obtaining information of red, green, blue and infrared (IR) lights, respectively. FIG. 2B shows a typical relative response of red, green, blue and IR lights.

The proximity sensor and the ambient light sensor used to control the power of light-emitting device of the SL projector incur design complexity, high power consumption and cost. Moreover, there may be a lack of proximity sensor and ambient light sensor made specifically for a certain range of infrared spectrum. A need has thus arisen to propose a novel scheme of adjusting power of a light-emitting device without using conventional proximity sensor and ambient light sensor.

### SUMMARY OF THE INVENTION

In view of the foregoing, it is an object of the embodiment of the present invention to provide a system and method of adjusting power of an infrared (IR) light-emitting device without using conventional proximity sensor and ambient light sensor but with a single IR sensor, thus substantially reducing design complexity, power consumption and cost.

According to one embodiment, a system of adjusting power of a light source includes an image sensor, a target object detection unit, a distance determination unit, a light energy measuring unit and a controller. The image sensor captures an image and obtains gain and exposure. The target object detection unit detects a target object in the image and finds a size of the target object. The distance determination unit determines distance of the target object according to the size of the target object. The light energy measuring unit measures light energy according to the gain and the exposure. The controller controllably adjusts power of the light source according to the distance and the light energy.

### BRIEF DESCRIPTION OF THE DRAWINGS

FIG. 1A shows one type of proximity sensors;

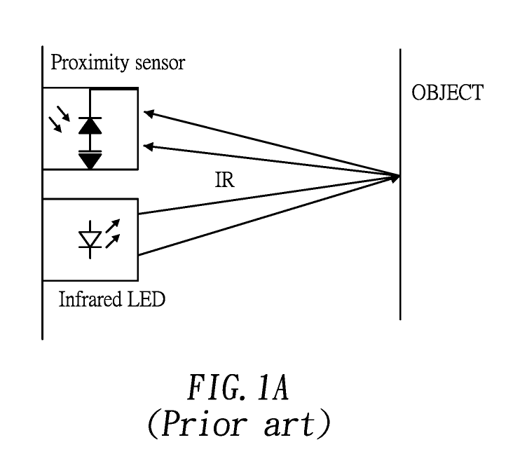

FIG. 1B shows another type of proximity sensors;

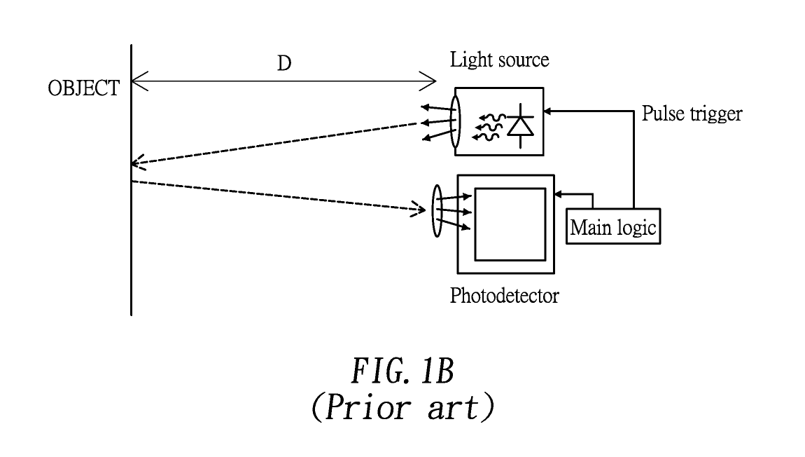

FIG. 2A shows a block diagram illustrating an ambient light sensor;

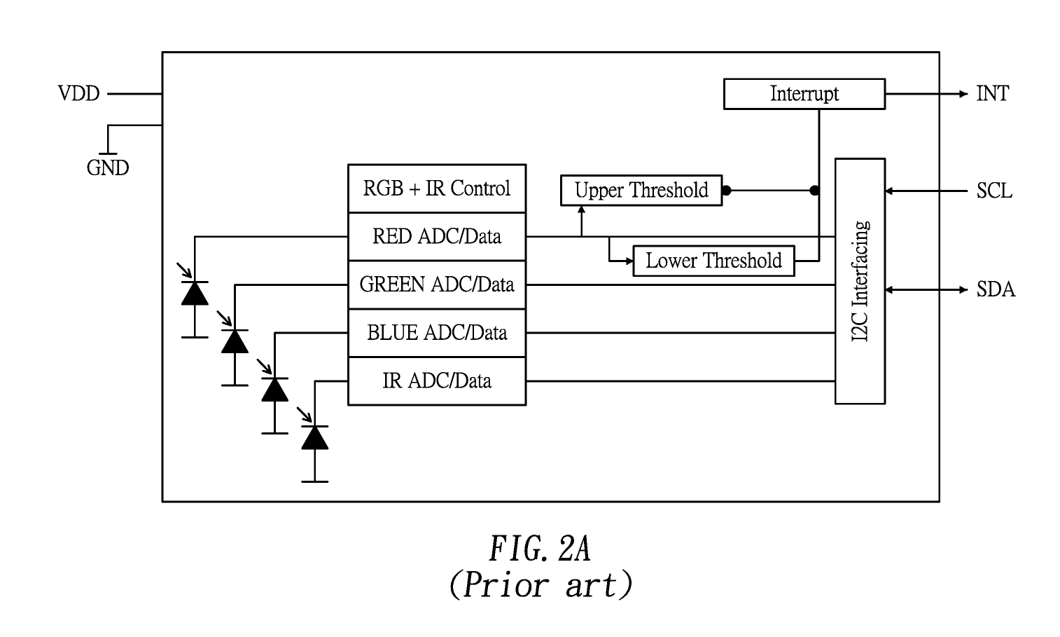

FIG. 2B shows a typical relative response of red, green, blue and IR lights;

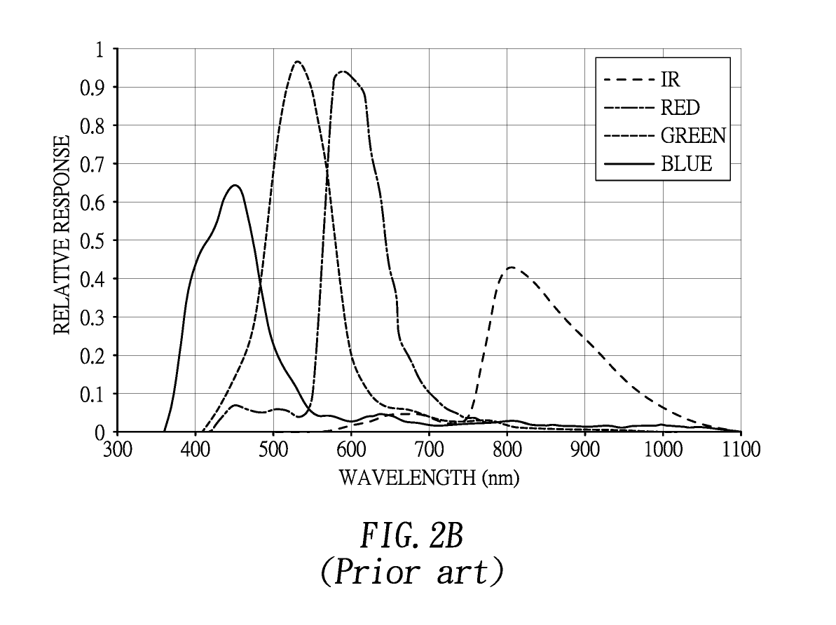

FIG. 3 shows a block diagram illustrating a system of adjusting power of a light source according one embodiment of the present invention;

FIG. 4 shows a flow diagram illustrating a method of adjusting power of the light source according to the embodiment of the present invention;

FIG. 5A shows exemplary IR images respectively captured at different distances;

FIG. 5B shows images associated with different distances, respectively; and

FIG. 6 shows exemplary IR images respectively captured with different exposure conditions.

### DETAILED DESCRIPTION OF THE INVENTION

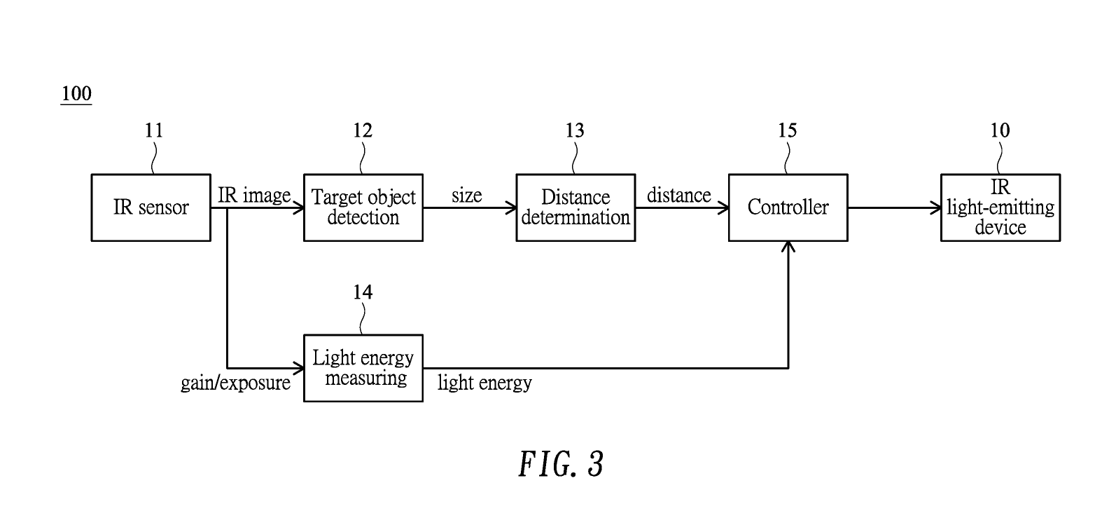

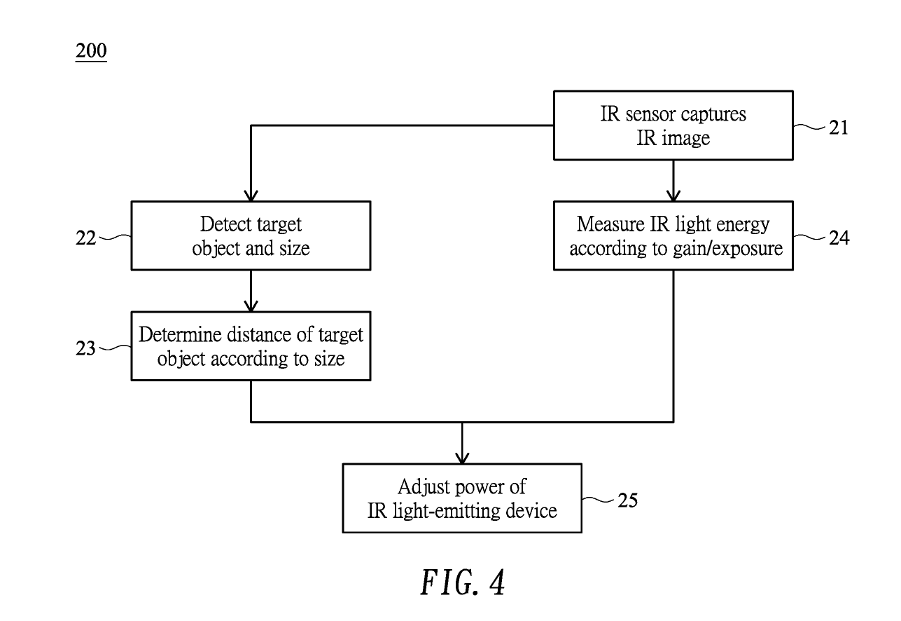

FIG. 3 shows a block diagram illustrating a system 100 of adjusting power of a light source such as an infrared (IR) light-emitting device 10 according one embodiment of the present invention, and FIG. 4 shows a flow diagram illustrating a method 200 of adjusting power of the light source (e.g., IR light-emitting device 10) according to the embodiment of the present invention. The blocks of the system 100 may be implemented by hardware, software or their combinations, and flow of the method 200 may be performed, for example, by a processor such as digital image processor. The system 100 of the embodiment may, for example, be adaptable to a structured-light (SL) projector that adopts the IR light-emitting device 10. Although the embodiment is directed to system/method operating in IR spectrum, it is appreciated that the present invention may also operate in visible spectrum.

In the embodiment, the system 100 may include an IR sensor (or an image sensor in general) 11 capable of detecting infrared light in a specific range (e.g., atmospheric window around 940 nm) of infrared spectrum. The IR sensor 11 of the embodiment may include, but not limited to, a complementary metal-oxide-semiconductor (CMOS) image sensor or CIS.

In step 21, the IR sensor 11 operatively captures an IR image (or an image in general). In the embodiment, the resolution of the IR image may, for example, be 640×480 (i.e., Video Graphics Array (VGA)) or 320×240 (i.e., Quarter Video Graphics Array (QVGA)). Specifically, the IR sensor 11 captures the IR image in automatic exposure (AE) mode. The task of capturing the IR image may obtain gain (e.g., automatic gain in this case) that represents amplification of signal from the IR sensor 11, and exposure that represents amount of light per unit area reaching the IR sensor 11. The use of the gain and the exposure will be explained later in this specification.

The system 100 of the embodiment may include a target object detection unit 12 configured to detect (or identify) a target object in the IR image (step 22). The task of detecting the target object may find a location and a size of the target object.

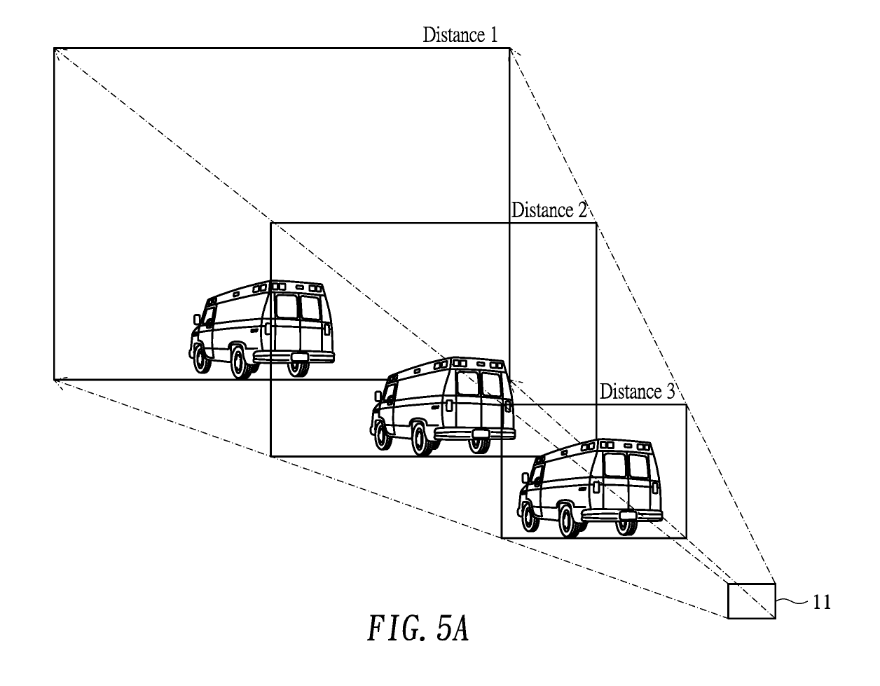

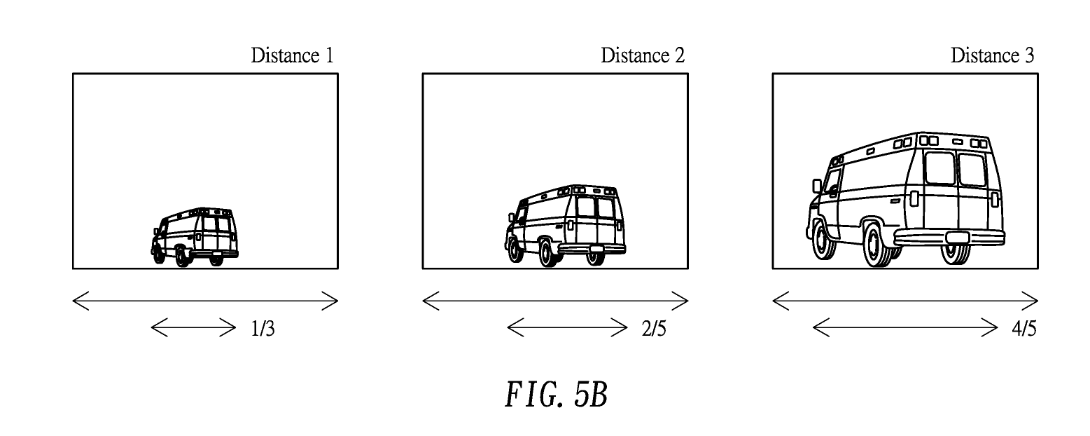

The system 100 of the embodiment may include a distance determination unit 13 configured to determine distance of the target object (from the IR sensor 11) according to the size of the target object in the IR image (step 23). FIG. 5A shows exemplary IR images respectively captured at different distances, for example, distance 1, distance 2 and distance 3 from far to near. FIG. 5B shows images associated with different distances, respectively. It is observed that a target object with a largest size in an IR image associated with distance 3 is nearest the IR sensor 11, and the target object with smallest size in an IR image associated with distance 1 is farthest from the IR sensor 11. That is, the farther is the target object, the smaller is the size of the target object in the IR image. In other words, the distance is inversely proportional to the size of the target object in the IR image. As exemplified in FIG. 5A, the distance of the target object (from the IR sensor 11) may be determined according to the size of the target object in the IR image, for example, by trigonometry. Therefore, the embodiment determines a distance representing proximity of the target object to the IR sensor 21 without using a conventional proximity sensor. In one embodiment, sizes of target objects and corresponding distances may be pre-measured and stored, for example, in a lookup table retrievable by the distance determination unit 13, thus saving runtime computation.

In the embodiment, the system 100 may include a light energy measuring unit 14 configured, in step 24, to measure (environmental) IR light energy according to the gain and the exposure obtained in step 21. Specifically, in the embodiment, the measured IR light energy is related to a product (or multiplication) of the gain and the exposure (i.e., gain*exposure). Particularly, the measured IR light energy is inversely proportional to the product of the gain and the exposure.

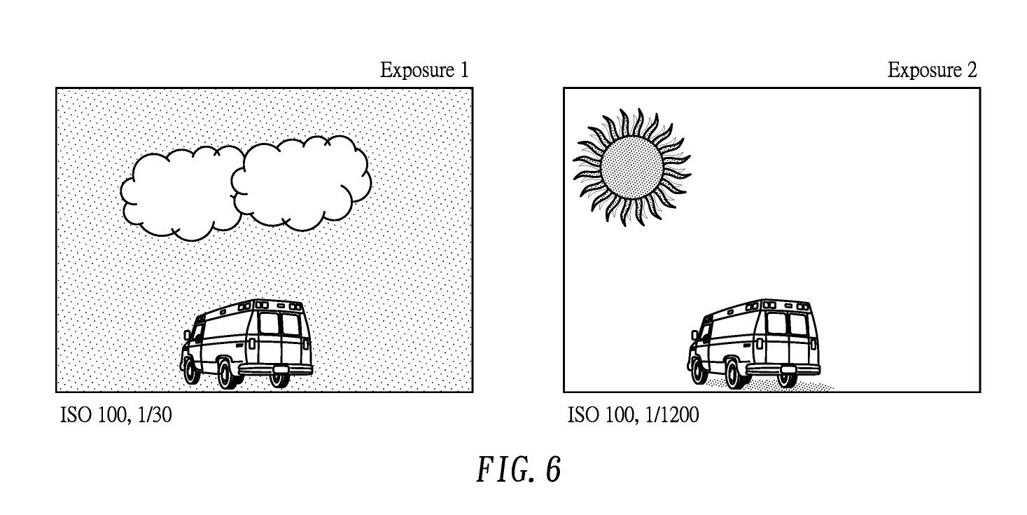

FIG. 6 shows exemplary IR images respectively captured with different exposure conditions, for example, exposure condition 1 and exposure condition 2 from high to low. It is observed that the IR image captured (in a cloudy day) with exposure condition 1 of ISO 100 (related to the gain) and shutter speed 1/30 (i.e., longer exposure) will measure lower IR light energy than the IR image captured (in a sunny day) with exposure condition 2 of ISO 100 and shutter speed 1/1200 (i.e., shorter exposure). Therefore, the embodiment determines IR light energy representing ambient light without using a conventional ambient light sensor. For the example shown in FIG. 6, the ambient light ratio of the IR image with exposure condition 1 to the IR image with exposure condition 2 is 1:40 approximately.

The light energy measuring unit 14 of the embodiment may include a band-pass filter configured to pass wavelengths (or frequencies) within a specific range (e.g., atmospheric window around 940 nm) of infrared spectrum, and to reject (or attenuate) wavelengths outside that range.

In the embodiment, the system 100 may include a controller 15 that operatively receives the determined distance (from the distance determination unit 13) and the measured light energy (from the light energy measuring unit 14), according to which the controller 15 may controllably adjust power of the IR light-emitting device 10, for example, of a SL projector (step 25). That is, the farther is the distance or higher is the light energy, more power is fed to the IR light-emitting device 10. According to the embodiment as discussed above, the system 100 and the method 200 can determine proximity and ambient light without using conventional proximity sensor and ambient light sensor but with a single IR sensor, thus substantially reducing design complexity, power consumption and cost.

Although specific embodiments have been illustrated and described, it will be appreciated by those skilled in the art that various modifications may be made without departing from the scope of the present invention, which is intended to be limited solely by the appended claims.

What is claimed is:

1. A system of adjusting power of a light source, comprising:
an image sensor for capturing an image and obtaining gain and exposure;
a target object detection unit that detects a target object in the image and finds a size of the target object;
a distance determination unit that determines distance of the target object according to the size of the target object;
a light energy measuring unit that measures light energy according to the gain and the exposure; and
a controller that controllably adjusts power of the light source according to the distance and the light energy.

2. The system of claim 1, wherein the light source comprises an infrared (IR) light-emitting device.

3. The system of claim 2, wherein the IR light-emitting device is adopted by a structured-light (SL) projector.

4. The system of claim 1, wherein the image sensor comprises an IR sensor.

5. The system of claim 1, wherein the image sensor comprises a complementary metal-oxide-semiconductor (CMOS) image sensor.

6. The system of claim 1, wherein the distance is inversely proportional to the size of the target object in the image.

7. The system of claim 1, further comprising a lookup table retrievable by the distance determination unit, the lookup table storing pre-measured sizes and corresponding distances of a plurality of target objects.

8. The system of claim 1, wherein the light energy is inversely proportional to multiplication of the gain and the exposure.

9. The system of claim 1, wherein the light energy measuring unit comprises a band-pass filter.

10. The system of claim 1, comprising no proximity sensor and ambient light sensor.

11. A method of adjusting power of a light source, comprising:
capturing an image and obtaining gain and exposure;
detecting a target object in the image and finding a size of the target object;
determining distance of the target object according to the size of the target object;
measuring light energy according to the gain and the exposure; and
controllably adjusting power of the light source according to the distance and the light energy.

12. The method of claim 11, wherein the light source comprises an infrared (IR) light-emitting device.

13. The method of claim 12, wherein the IR light-emitting device is adopted by a structured-light (SL) projector.

14. The method of claim 11, wherein the image is captured by an IR sensor.

15. The method of claim 11, wherein the image is captured by a complementary metal-oxide-semiconductor (CMOS) image sensor.

16. The method of claim 11, wherein the distance is inversely proportional to the size of the target object in the image.

17. The method of claim 11, further comprising a step of retrieving a lookup table that stores pre-measured sizes and corresponding distances of a plurality of target objects.

18. The method of claim 11, wherein the light energy is inversely proportional to multiplication of the gain and the exposure.

19. The method of claim 11, wherein the light energy is measured by a band-pass filter.

20. The method of claim 11, comprising not using a proximity sensor and an ambient light sensor.
